(19) United States
(12) Patent Application Publication
(10) Pub. No.: US 2008/0153361 A1
(43) Pub. Date: Jun. 26, 2008

(54) SCREW-TERMINAL BLOCK ASSEMBLY WITH SNAP-IN CONTACT MEMBER

(75) Inventor: GERALD K. HEIN, Pullman, WA (US)

Correspondence Address: Richard Edge;Schweitzer Engineering Laboratories, Inc., 2350 NE HOPKINS COURT, PULLMAN, WA, 99163-5603, US

(73) Assignee: SCHWEITZER ENGINEERING LABORATORIES, INC., PULLMAN, WA (US)

(21) Appl. No.: 11/613,504

(22) Filed: Dec. 20, 2006

(51) Int. Cl. H01R 9/24; H01R 4/30

(52) U.S. Cl. 439/709; 439/810

(57) ABSTRACT

The screw-terminal block assembly includes a screw-terminal block and a snap-in contact member which is adapted to be crimped at one portion thereof to a lead wire, the snap-in contact member including lance portions which are moveable and flex relative to the remainder of the contact member so as to allow the contact member to be inserted into the terminal block, the lance portions rebounding to engage a mating portion of the terminal block when the snap-in contact member is correctly positioned in the terminal block. The snap-in contact member further includes a portion which is configured to receive a terminal screw for an electrical lead connection, such as from an electronic instrument.

### TECHNICAL FIELD

This invention related relates generally to screw-terminal block assemblies, and more specifically concerns such an assembly which includes a new wire connector arrangement.

### BACKGROUND OF THE INVENTION

Conventional screw-terminal assemblies, such as shown in FIG. 1, include a standard terminal block 10 and an insert member mounted in the terminal block 10. The insert member is adapted to receive a terminal screw at one side of the terminal block 10. At the other side of the terminal block 10, the insert member includes an extending terminal portion 15 which receives a spade connector 18 which is crimped to a connecting wire. It could also be connected by a wire wrap or solder.

The standard terminal block assembly of FIG. 1 requires three separate assembly connections, including crimping (or otherwise connecting) the spade connector 18 to the connecting wire, plugging the spade connector onto the extending terminal portion 15 of the insert member and connecting a screw terminal lead to the screw in the insert member on the opposite (screw) side of the terminal block. The step of plugging the spade connector onto the extending terminal portion of the insert member is labor-intensive and typically requires a high force for proper insertion. This can result in damaged terminal portions, spades which are not fully seated on the terminals, and discomfort of and possible injury of assemblers over the long term.

Hence, it is desirable to have a screw-terminal block assembly in which assembly operations are simplified and can be accomplished with less physical risk on the part of the assembler.

### DISCLOSURE OF THE INVENTION

Accordingly, an embodiment of the present invention includes a screw-terminal block assembly, comprising: a screw terminal block; and a snap-in contact member which includes one portion adapted to receive a screw member, and another portion adapted to be connectable to an external lead wire, the snap-in contact member being adapted to be fittable in a mating portion of the terminal block and resistive to removal from the terminal block once fitted therein.

### BRIEF DESCRIPTION OF THE DRAWINGS

FIG. 1 is a perspective view of a prior art screw-terminal block assembly.

FIG. 2 is a perspective view of the screw-terminal block assembly described herein.

FIG. 3 is a perspective view of an alternative embodiment to the screw terminal contact member of the FIG. 2.

FIG. 4 is a cross-sectional view of the screw-terminal block assembly of the embodiment of FIG. 2.

FIG. 5 is another cross-sectional view of the embodiment of FIG. 2 at 90° relative to that of FIG. 4.

### BEST MODE FOR CARRYING OUT THE INVENTION

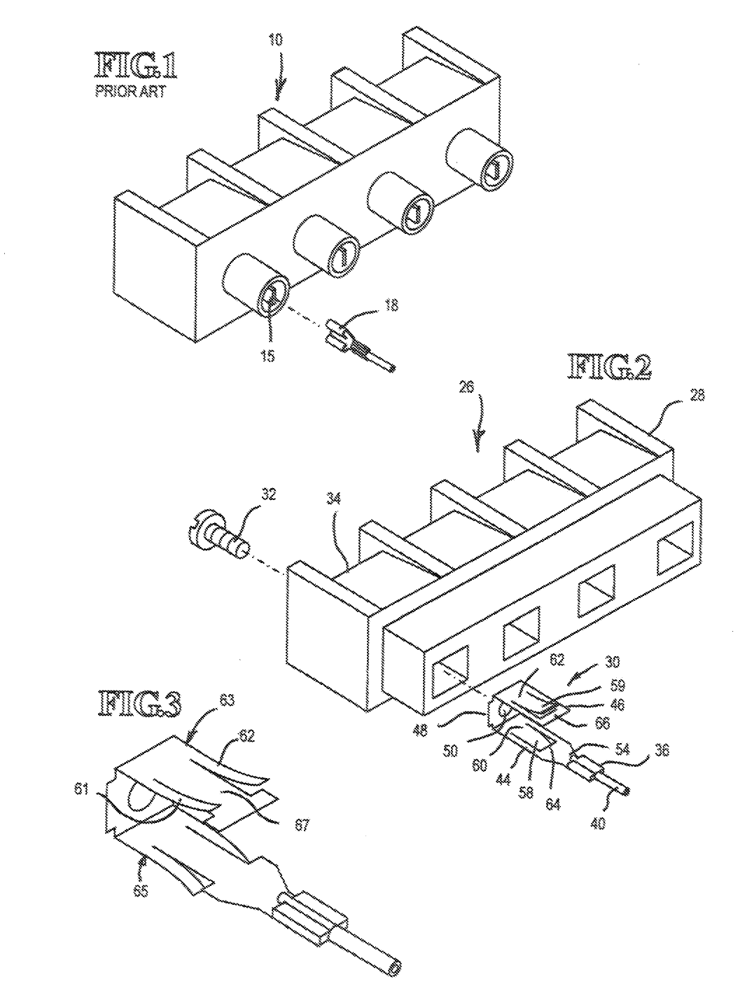

FIG. 2 shows an embodiment of the present invention, referred to generally at 26, which includes a terminal block 28 and a snap-in contact member 30, which is configured to snap into and be held by terminal block 28. Contact member 30 is adapted to receive a screw 32 at one side 34 of the terminal block 28 when the contact member 30 is seated in the terminal block 28, or it can be pre-assembled prior to snap-in of the contact member 30. Snap-in contact member 30 includes a crimp portion 36 which extends outwardly from the other side of the terminal block 28 when the contact member 30 is seated in the terminal block 28. The crimp portion 36 is crimped to a connecting electrical lead wire 40.

The snap-in contact member 30 is unitary and includes along its length two opposing side portions 44 and 46, joined by an intermediate portion 48. The snap-in contact member 30 in the embodiment shown in made from metal, such as brass or a copper alloy and is approximately 1/32 inch thick. The intermediate portion 48 includes an opening 50, which could be threaded, or a separate nut could be used to receive and hold screw 32 or similar element which connects an electrical lead to the terminal block assembly.

In the embodiment shown, side portion 44 is approximately ¾ inch long and includes a tapered end part 54 which can be crimped to an end of connecting lead wire 40 by crimp portion 36. The remainder of side portion 44, as well as side portion 46 and intermediate portion 48 is approximately 0.35 inches wide. These dimensions, however, can vary depending upon the configuration of the terminal block and the particular application.

The side portions 44 and 46, respectively, include partially cut-out lance sections 58 and 59. The lance sections 44 and 46 are movable relataive to the remainder of the side portions 44 and 46, respectively, about hinge-like ends 60 and 62. The free end edges 64 and 66 of the lance sections stand slightly away from the remainder of the side portions in their normal position. In the embodiment shown, lance sections 58 and 59 are approximately 0.250 inches long by 0.20 inches wide and at the free edges 64,66 thereof extend outwardly from the side portions approximately 0.05 inch.

An alternate contact member arrangement is shown in FIG. 3. In this embodiment, there are two lance portions in each of the side portions 63 and 65. The two lance portions 61 and 62 are located at the edges of the side portions, with an intermediate portion 67 therebetween.

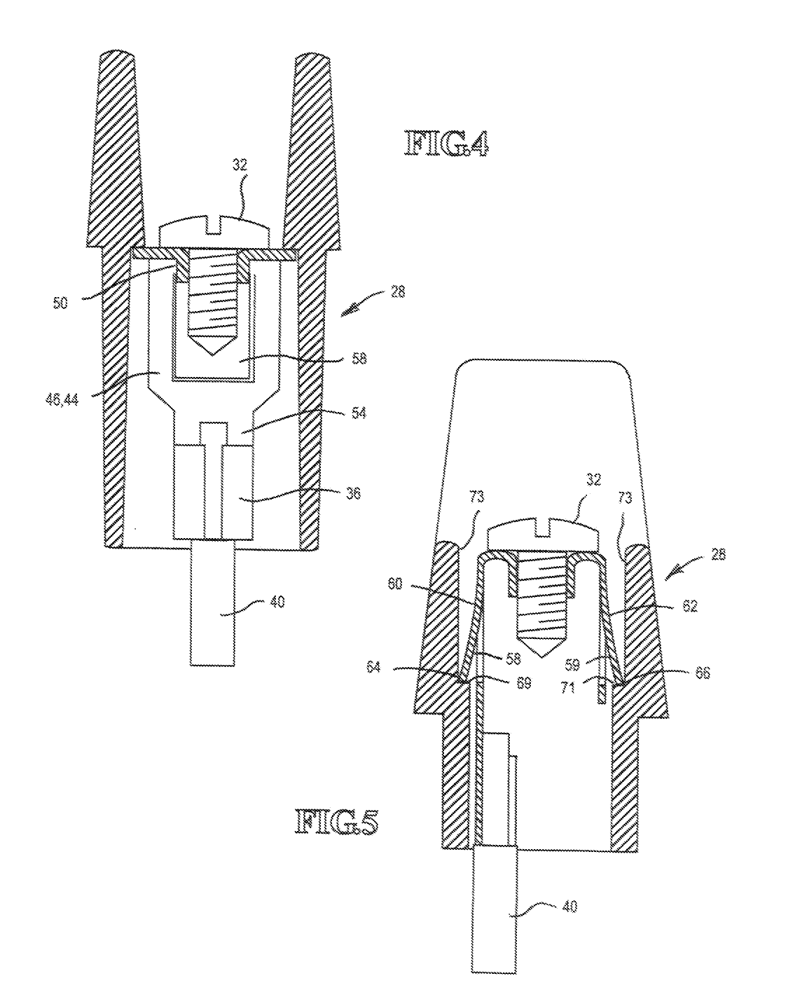

FIGS. 4 and 5 show the snap-in contact member 30 in place in terminal block 28. Threaded screw 32 will typically first be threaded into opening 50 in the intermediate portion 48 of the contact member. The peripheral edge of opening 50 is configured (threaded) to receive the threaded screw tightly. A lead wire connection, such as an output lead from an electronic instrument, can be inserted and held under the screw 32 when the contact member 30 is in place on the terminal block 26.

The terminal block has an internal surface configuration which includes lip portions 69 and 71 which extend inwardly a short distance from the remaining interior surface 73 of the terminal block.

As the contact member is inserted, lance sections 58 and 59 (the embodiment of FIG. 2) move inwardly about ends 60 and 62, until the free ends 64 and 66 of the lance sections pass beyond the lip portions 69 and 71, at which point the lance sections 58 and 59 spring outwardly back into their original positions, contacting the interior surface 73 of the terminal block adjacent the lip portions 69 and 71. At this point, the snap-in contact member 30 is locked into place within the terminal block 28, the lance sections 58 and 59 thereby resisting removal of the snap-in contact member 30. The correct locking of the contact member 30 provides an audible feedback to the assembler.

This assembly sequence action is less demanding physically on the assembler than repeatedly making spade connections in conventional screw terminal assemblies, with a consequential reduction in discomfort and injury.

Following similar assembly steps for each snap-in contact member used in the terminal block, the terminal block assembly 26 is ready for use. Connections to the terminal block assembly on the screw 32 side can be made by partially unthreading the screw 32, positioning the desired electrical lead under the screw and then tightening the screw 32.

Hence, a new terminal block assembly has been disclosed having a structure which is more convenient to assemble, requiring fewer actions on the part of the assembler.

Although a preferred embodiment of the invention has been disclosed for purpose of illustration, it should be understood that various changes, modifications and substitutions may be incorporated in the embodiment without departing from the spirit of the invention which is defined by the claims which follow.

1. A screw-terminal block assembly, comprising:
a screw terminal block; and
a snap-in contact member which includes two substantially opposing parallel side portions, and an intermediate portion joining the two side portions, wherein one side portion includes an end part adapted to be electrically coupled to an external lead wire, one of the portions thereof adapted to receive a screw member. snap-in contact member being adapted to be fittable in a mating portion of the terminal block and resistant to removal from the terminal block once fitted therein.

2. The terminal block assembly of claim 1, wherein the snap-in contact member includes at least one lance portion which moves relative to the remainder of the contact member so that the contact member fits in the mating portion of the terminal block, and which rebounds when the contact member is correctly positioned in the terminal block, thereby resisting removal of the contact member from the terminal block.

3. The terminal block assembly of claim 2, wherein the mating portion comprises a lip portion configured to engage and retain the lance portion of the snap-in contact member.

4. The terminal block assembly of claim 1, wherein the end part is adapted to be crimped to the external lead wire.

5. The terminal block assembly of claim 4, wherein the opposing side portion is readily movable about the end thereof where it joins the intermediate portion.

6. The terminal block assembly of claim 4, wherein the two substantially opposing parallel side portions each include lance portions which move relative to the remainder of the contact member and which rebound when the contact member is correctly positioned in the terminal block, so as to hold the contact member in place in the terminal block.

7. The terminal block assembly of claim 4, wherein each opposing parallel side portion includes a plurality of lance portions.

8. The terminal block assembly of claim 1, wherein the portion adapted for receiving a screw member includes an opening having an edge which is adapted to threadably receive and engage said screw.

9. The terminal block assembly of claim 1, wherein the terminal block includes a plurality of openings to receive a corresponding number of snap-in contact members.

10. The terminal block assembly of claim 9, wherein each of the plurality of openings includes a lip portion which is configured to engage and retain the lance portions of snap-in contact members.
